(19) United States
(12) Patent Application Publication
(10) Pub. No.: US 2004/0210696 A1
(43) Pub. Date: Oct. 21, 2004

(54) Method and apparatus for round robin resource arbitration

(76) Inventors: Michael J. Meyer, Palo Alto, CA (US); Drew Wingard, San Carlos, CA (US); Wolf-Dietrich Weber, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/418,624

(22) Filed: Apr. 18, 2003

(51) Int. Cl. G06F 13/14

(52) U.S. Cl. 710/240

(57) ABSTRACT

A method and apparatus for a round robin resource arbitration scheme is described. An apparatus to provide round robin token arbitration comprises at least two token arbiters, each token arbiter associated with a node to which at least two sub-trees are connected, each sub-tree comprising a token arbiter or a finite state machine requestor.

### FIELD OF THE INVENTION

The present invention relates to resource arbitration, and more particularly a round robin scheme for resource arbitration.

### BACKGROUND

When there is a resource that is shared by multiple requestors, and only one requestor can use the resource in a specific period (typically one clock cycle) it is necessary to have an arbiter that accepts requests and ensures that only one requestor is granted use of the resource. Examples of shared resources include a network, bus, and silicon backplane. The ownership of the shared resource may be designated by ownership of a “token”. Round robin arbitration is a commonly used arbitration policy because it ensures equal and fair access to a resource. In a round robin arbitration policy the requesters are assigned a fixed order of priority rotation. For example, the order of three requesters could be R1, R2, R3 and back to R1. The requestor that was granted the token last is considered the lowest priority and the requestor after it is considered the highest priority. For example, if R2 was the last unit to be granted a request, then R3 would be the highest priority, followed by R1 and finally R3. If R3 requests and is granted the token, then it would become the lowest priority, so the arbitration order would be R1, R2, then R3.

The ownership of the token indicates both ownership of the resource and the lowest priority requestor. For efficient use of a shared resource it is usually desirable to be able to grant a new request in each cycle, which means that the token must be able to pass from any owner to then next owner in one cycle. Ownership of the token may imply ownership of the shared resource in the same cycle, or in the next cycle.

One prior art implementation of such a token passing mechanism is a distributed daisy chain illustrated in FIG. 1. In that example, each requestor has one bit of state that is “one” when they own the token, which means they have been granted use of the resource and are the lowest priority for the next arbitration cycle. If a requester does not need the token, it is offered to the next lower priority requester. This process continues around the ring until either there is an active requestor or it returns to the current token owner. When the token is granted to a requester, the requestor who now owns the token becomes the lowest priority, and the next requester in the ring is the highest priority. The token doesn't move if there are no requestors in a cycle. However the daisy chain implementation must deal with a false combinatorial loop that is problematic for static timing analysis. Furthermore, the timing of the ring degrades linearly with number requestors in the ring and the length of the ring.

FIG. 2 illustrates a centralized arbitration scheme, which requires that all the request signals be sent to the central arbitration unit, where one of N priority encoders are enabled. The combinatorial logic in this approach grows as the square of the number of requesters. It also suffers from significant fan-out delays on the request inputs and fan-in delays on the grant outputs, as well as delays from repeaters inserted in the request and grant signals to distribute them to and from the centralized arbiter.

FIG. 8 illustrates a tree structured token ring with 4 request signals. The tree is made up of aggregators connected together hierarchically. The leaves are aggregators with only a local connect to the current token ring state machines at each initiator. The top (or root) of the tree is an aggregator with the grant input from the top wired on, and the request output to the top ignored. Aggregators have 3 inputs from the bottom, one to connect to the left, one to the right, and the third to connect to the local initiator, but the function works for 2 or more inputs. Each requestor has a one-hot, 4-bit request input. The tree has n 4-bit requests, where n is the number of lower-level requestors to be aggregated. The 4 bits of request input have the following meaning:

HAVETOKEN have token and am highest priority requestor

GENTOKEN have token but am lowest priority requestor

WANTTOKEN don't have token but want it

NOTOKEN don't have token and don't want it

Each node in the tree further outputs n single-bit grants downstream, and a one-hot 4 bit request upstream, implemented by the equations below. It further has the additional input of a single bit grant, from upstream.

```
root[HAVETOKEN] = rightF[HAVETOKEN]
        OR localF[HAVETOKEN]
        OR leftF[HAVETOKEN]
        OR (left[FGENTOKEN] AND localF[WANTTOKEN])
        OR (leftF[GENTOKEN] AND rightF[WANTTOKEN])
        OR (localF[GENTOKEN] AND rightF[WANTTOKEN])
            ;
root[GENTOKEN] = rightF[GENTOKEN]
        OR (localF[GENTOKEN] AND !rightF[WANTTOKEN])
        OR (leftF[GENTOKEN] AND !rightF[WANTTOKEN]
            AND !localF[WANTTOKEN])
root[WANTTOKEN] = (rightF[WANTTOKEN]
            AND (localF[NOTOKEN] OR localFI[WANTTOKEN])
            AND (leftF[NOTOKEN] OR leftF[WANTTOKEN]))
        OR (localF[WANTTOKEN]
            AND (leftF[NOTOKEN] OR leftF[WANTTOKEN])
            AND !rightF[HAVETOKEN] AND !rightF[GENTOKEN])
        OR (leftF[WANTTOKEN]
            AND !localF[HAVETOKEN] AND !localF[GENTOKEN]
            AND !rightF[HAVETOKEN] AND !rightF[GENTOKEN])
root[NOTOKEN] = rightF[NOTOKEN] AND localF[NOTOKEN]
              AND leftF[NOTOKEN]
rootF = root (with fast buffer)
rootS = root (with slow buffer)
rightGnt = rootGnt AND (rightS[HAVETOKEN]
    OR (right[SWANTTOKEN] AND localS[GENTOKEN])
    OR (rightS[WANTTOKEN] AND localS[NOTOKEN] AND
    leftF[GENTOKEN])
    OR (rightS[WANTTOKEN] AND localS[NOTOKEN] AND
    leftS[NOTOKEN])
    OR (rightS[GENTOKEN] AND localS[NOTOKEN] AND
    leftS[NOTOKEN]))
localGnt = rootGnt AND (localS[HAVETOKEN]
    OR (localS[WANTTOKEN] AND leftS[GENTOKEN])
    OR (localS[WANTTOKEN] AND leftS[NOTOKEN]
            AND !rightS[HAVETOKEN])
    OR (localS[GENTOKEN] AND leftS[NOTOKEN] AND
    rightS[NOTOKEN]))
leftGnt = rootGnt AND (leftS[HAVETOKEN]
    OR (leftS[WANTTOKEN] AND !localS[HAVETOKEN]
          AND !(rightS[WANTTOKEN] AND localS[GENTOKEN])
        AND !rightS[HAVETOKEN])
    OR (leftS[GENTOKEN] AND localS[NOTOKEN] AND
    rightS[NOTOKEN]))
```

Unused inputs to the Token Arbiter are tied off, with the NOTOKEN input being tied to 1, and the others being tied to 0. The root grant signal is tied to 1.

In order to improve the timing of this implementation the request is sent twice, once with large buffer for fast timing (rootF) for use in the request to the root and once with more relaxed timing for the grant down logic (rootS). Thus this implementation actually uses 8 signals to send a request up the tree. This requires significantly more wiring than other approaches, and thus is disadvantageous.

### SUMMARY OF THE INVENTION

A method and apparatus for a round robin resource arbitration scheme is described. An apparatus to provide round robin token arbitration comprises at least two token arbiters, each token arbiter associated with a node to which at least two sub-trees are connected, each sub-tree comprising a token arbiter or a finite state machine requestor.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an implementation of a prior art daisy chain token arbitration scheme.

FIG. 2 is an implementation of a prior art centralized token arbitration scheme.

FIG. 3A is an exemplary chip layout using the round robin arbitration scheme of the present invention.

FIG. 3B illustrates the arbitration tree structure obtained using the layout of FIG. 3A.

FIG. 4 illustrates one embodiment of a token tree structure in accordance with the present invention.

FIG. 5A illustrates one embodiment of a token ring arbiter cell.

FIG. 5B illustrates another embodiment of the token ring arbiter cell.

FIG. 6A illustrates one embodiment of a token ring arbiter root cell.

FIG. 6B illustrates another embodiment of the token ring arbiter root cell.

FIG. 7 illustrates one embodiment of the finite state machine representing token ring arbitration.

FIG. 8 illustrates a distributed, tree-structure arbiter using 8-wires between arbiters.

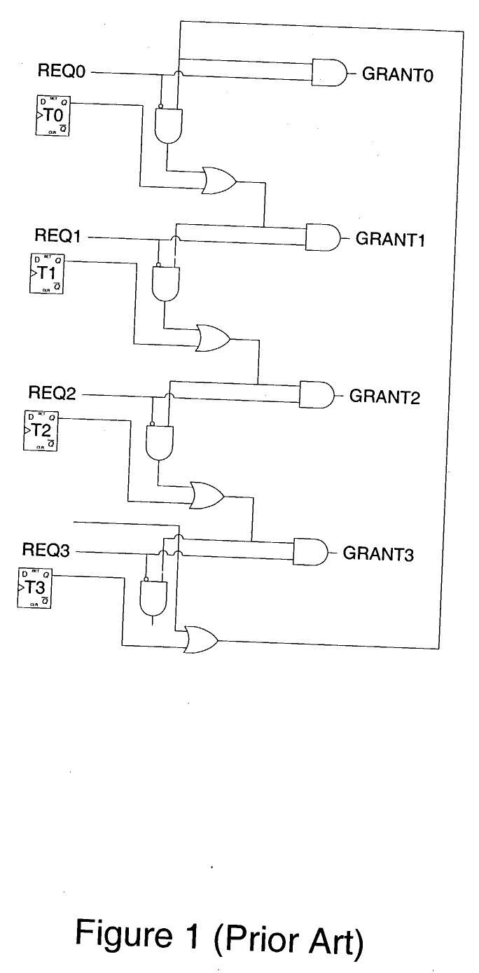

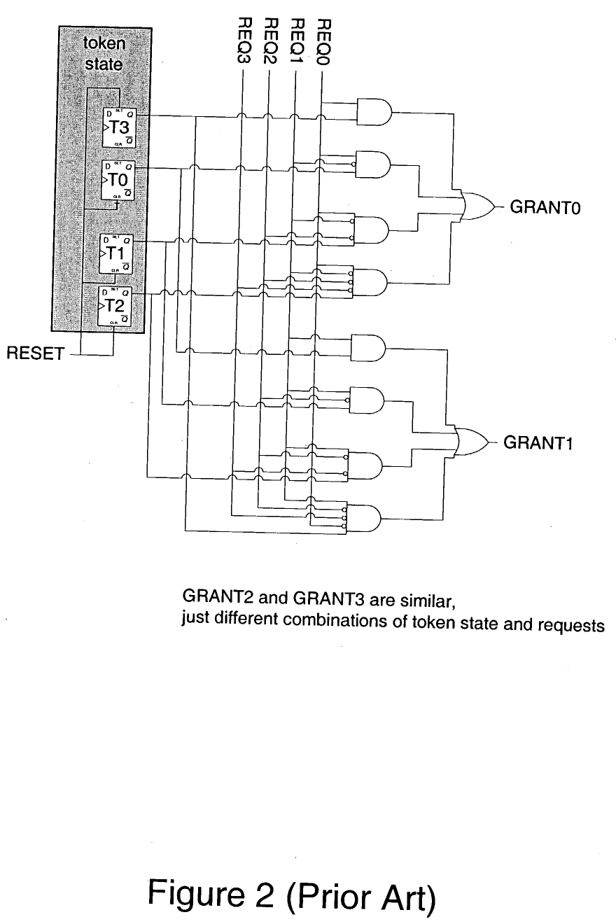

### DETAILED DESCRIPTION

A method and apparatus for round robin arbitration is described. Arbitration for a shared resource is critical to the performance of many systems. Round robin arbitration is a good arbitration policy because of its simplicity and fairness. When the requesters are distributed, the time it takes to both receive the request and return the grant of the request can be as critical as the time it takes to do the arbitration.

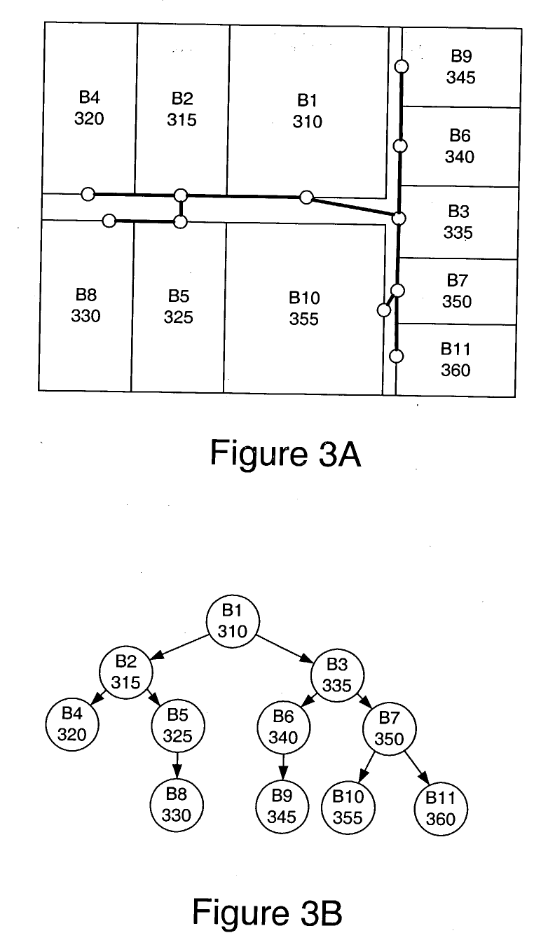

A tree-based arbitration structure can efficiently traverse distances in a 2-D structure of an integrated circuit chip as seen in FIG. 3A. For example, the integrated circuit may be a system on a chip (SOC).

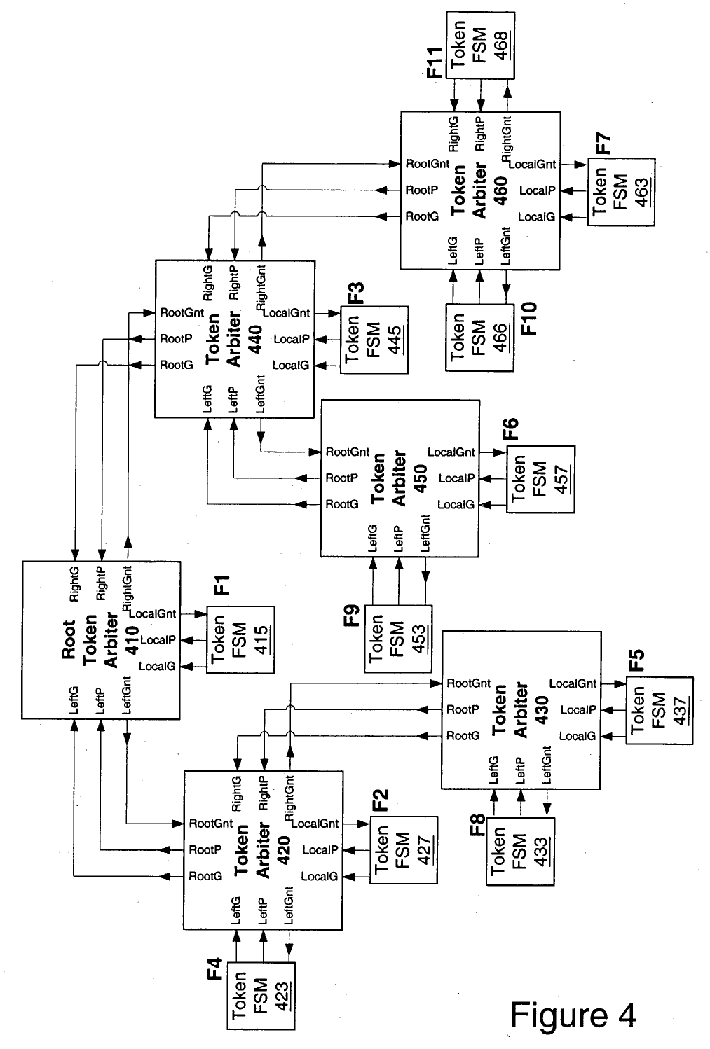

The layout of FIG. 3A shows root node B1 310, and its subsidiary nodes. FIG. 3B illustrates the tree structure formed by the requesters of the chip of FIG. 3A. The nodes B1 through B11 represent an arbiter or a requestor. In FIG. 3A the arbiters are: B1 (root), B2, B5, B3, B6, and B7. In other words, each of the nodes that has at least one subsidiary node (in addition to the local requestor) has an arbiter. This is shown in more detail in FIG. 4.

The actual ordering of the nodes may be chosen to minimize the maximum length from the root to any leaf. Thus, for one embodiment, the designer may optimize the ordering of the nodes to balance the tree. Thus, the designer may choose the root node, and the connections between nodes to minimize the maximum travel time for the token. Here, the maximum travel time is either from requestor B8 to root B1 or from requestor B9 to root B1. For the traversal from B8, the token must travel upstream through nodes B5 and B2 to root B1 and back. For the traversal from B9, the token must travel up through nodes B6 and B3 to root B1 and back. The root of the tree is located in the optimal location when the critical paths of the two sub-trees connected to the root are comparable. If the critical path for one of the sub-trees is considerably longer than the other sub-tree, then it is likely that making the root of the longer sub-tree the root of the overall tree will better balance the delay of the tree.

With the organization of FIG. 4, both sub-tree critical paths take 6 steps. If the circuit were implemented using the daisy chain method described above, the maximum distance would be 11 steps. If the number of requestors double, the number of steps in the tree structure would increase by 2, while the number of steps in the daisy chain would double.

By performing a distributed arbitration at each node of the tree, the desired round robin arbitration logic is implemented, and the signals are buffered as they traverse the chip.

FIG. 4 illustrates the token tree structure consisting of arbiter cells and arbiter FSM needed to implement the round robin arbitration for the chip shown in FIG. 3. The distance the signals must travel is less than in the token ring structure. Furthermore, the number of signals that are passed root or hub 410 is considerably less than in the centralized approach—3 each from Token Arbiter 420 and Token Arbiter 440 compared to the centralized arbiter which would require 22 signals (2 each from all 11 requestors).

One aspect of the distributed implementation is the encoding of the request signal as it is sent up the tree. As shown in FIG. 4, two signals are used to send the request up the tree: The first is a generate signal (G) that indicates that the token is being passed upstream toward the root by this sub-tree because the token is currently held by one of the requestors in this sub-tree and there are no active requesters in this sub-tree that are higher priority than requestors in the rest of the tree. The second is a propagate signal (P) that indicates that this sub-tree contains no active requesters and does not hold the token.

In one embodiment, both G and P will never be true in the same cycle. This fact leads to several optimizations described later.

The G and P signals for a sub-tree (rootG and rootP) can be generated from its local and sub-tree P and G inputs. In FIG. 4, the sub-tree P and G inputs are illustrated as LocalG and LocalP for the local sub-tree, LeftG and LeftP for the left sub-tree, and RightG and RightP for the right sub-tree. If the local node and the sub-trees all are propagating the token, then the sub-tree is propagating the token. The round robin order within the sub-tree affects the generation of the sub-tree's G output and the generation of the grants when the token is passed down to the sub-tree. In one embodiment, the round robin order is local, right, and then left.

The grant (Gnt) signal is propagated down to the requester with the highest priority. For one embodiment, the priority is local, right, and then left. Thus, in the example shown in FIG. 4, the round robin order is: F1, F3, F7, F11, F10, F6, F9, F2, F5, F8, F4, and back to F1

While FIG. 4 illustrates a binary tree, it can be scaled to higher order trees. In particular a tree with a local node and three sub-trees may be useful in certain chip designs. For example if the root is located on the north side, it may be useful to have sub-trees branching out to the east, west, and south in addition to the local requestor. It may also be useful to have an arbiter without a local requester, especially if there are requests converging from two or three directions. In another embodiment, this is not necessary since the branch in the direction of the local requestor is not needed. Thus, if there are additional requesters, the arbitration logic can be extended with another requestor, or another arbitration node can be inserted.

The ordering of the local node, left sub-tree, and right sub-tree is arbitrary and does not affect the fairness of the arbitration, but does affect the timing of the arbiter. The ordering of the arbitration should optimize the paths from the left and right sub-trees since they are typically remote and involve extra levels of logic if they are also sub-trees.

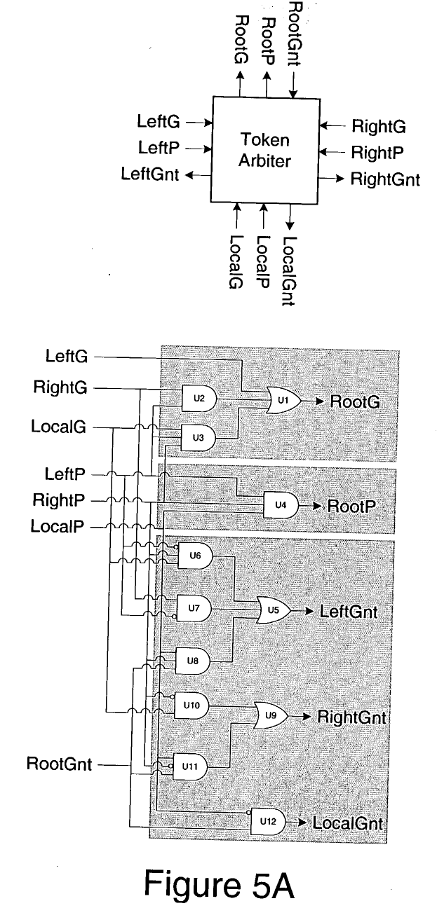

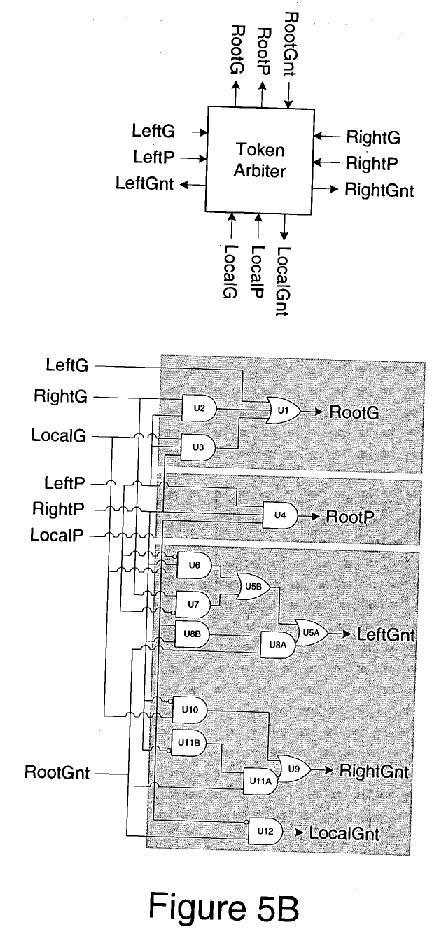

FIG. 5A illustrates one embodiment of a token arbiter. In the example shown the round robin order is local, right, and then left. Given this ordering, the sub-tree generates the token whenever left generates (LeftG into U1) or right generates it and left propagates it (U2), or local generates and both left and right propagate it (U3). A sub-tree propagates the token when all the lower levels of the sub-tree propagate the token (U4). Note that P is faster than G since it only requires one level of logic, while G requires two levels.

As illustrated in FIG. 5A the token arbitration cell optimizes the RootG generation from the left cell. By adopting an arbitrary convention where the left sub-tree is the longer of the two sub-trees the paths through RootG are balanced, since the path from LeftG to RootG is only one level of logic (U1) while RightG to RootG is two levels (U2 and U1).

One consequence of this ordering is that the generation of LeftGnt is more complex than both RightGnt and LocalGnt. However, the effect of this complexity on timing can be reduced by restructuring the logic and optimizing the path from the timing critical signal RootGnt.

As seen in FIG. 5B this path can be simplified to 1 complex gate or 2 simple 2-input gates by transforming U5, U8, and U11 into U5A and U5B, U8A and U8B, and U11A and U11B respectively. Thus the timing on LeftGnt is comparable to RightGnt. This optimization may be done directly at the gate level or through the timing constraints to logic synthesis, in which the path from RootGnt to LeftGnt and RightGnt are constrained to take less time than the paths from the other inputs to the arbiter cell.

Thus, the logic illustrated in FIG. 5B is as follows:

RootG=LeftG OR (RightG AND LeftP) OR (LocalG AND LeftP AND RightP)

RootP=LeftP OR RightP OR LocalP

LeftGnt=((!LeftP AND RightP AND LocalG) OR (!LeftP AND RightG)) OR ((LocalP AND RightP) AND RootGnt))

RightGnt=(!RightP AND LocalG) OR ((LocalP AND !RightP) AND RootGnt))

LocalGnt=(!LocalP AND RootGnt)

In one embodiment, each token arbiter is identically designed, and includes local, left, and right sub-trees. However, in some instances, only a subset of the finite state machines or arbiters that may be connected are used. In that instance, for one embodiment, unused G and P inputs to the arbiter node are tied off to zero. This allows the unnecessary logic associated with this requestor to be removed during logic synthesis.

In the prior art, the token FSM was only connected to the local interface. Instead of connecting an FSM to the left or right interfaces it would be connected to an arbitration unit with the left and right requests tied to zero. Logic synthesis with these tie-offs removes all the gates in the arbitration unit except U12. U12 is unnecessary because the arbitration unit can never receive a grant when P is asserted. In the current design, for one embodiment, arbitration units are only used when more than one unit or sub-tree is connected to them. This eliminates two logic gates for each token arbiter that has a Left and Right sub-tree.

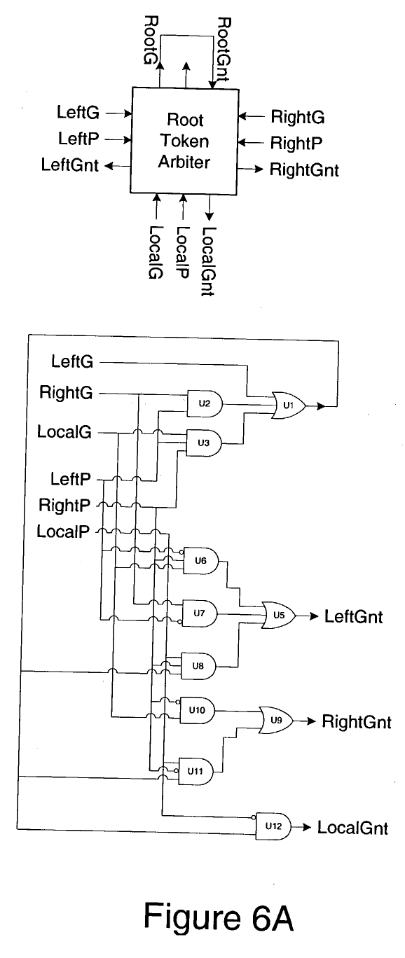

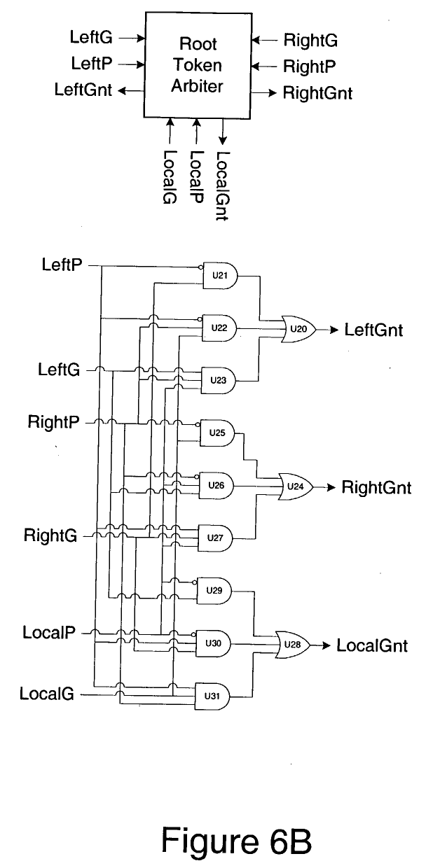

FIG. 6A is one embodiment of a root node arbiter. The generate signal at the root node, RootG, is feed back to itself as the grant input, RootGnt as shown in FIG. 6A. This completes the loop allowing the token to restart at the beginning of the tree when no other nodes after the current location are requesting it.

However, the direct connection of RootG to RootGnt is not optimal. There is redundancy in the terms of U8—RightG and RightP, which are never asserted at the same time are both fed into U8 (RightG via U2 and U1). Furthermore, in order to calculate the RightGnt and LocalGnt signals, the system must first calculate RootGnt. Therefore, there is a delay before RightGnt and LocalGnt are calculated.

FIG. 6B illustrates one embodiment of the optimized root structure, which eliminates this delay. As can be seen, in the optimized root structure is only two layers deep for all outputs.

Thus, the logic illustrated in FIG. 6B is as follows:

LeftGnt=(!LeftP AND RightG) OR (!LeftP AND RightP AND LocalG) OR (LeftG And RightP and LocalP)

RightGnt=(!RightP AND LocalG) OR (!RightP AND LocalP AND LeftG) OR (RightG AND LeftP AND LocalP)

LocalGnt=(!LocalP AND LeftG) OR (!LocalP AND LeftP AND RightG) OR (LeftP AND LocalG AND LeftG)

In one embodiment, in order to handle the distances traveled by some of the signals, the outputs of the arbiter cells are buffered. In one embodiment, this is done by replacing AND and OR output gates with NAND and NOR gates respectively and then feeding the output of these gates into the input of a high-powered inverter that then drives the output. As the actual wiring lengths between arbiters is determined, additional buffering may be added, either by hand or by automated logic synthesis, placement, routing, or other optimization programs to achieve targeted operating frequencies.

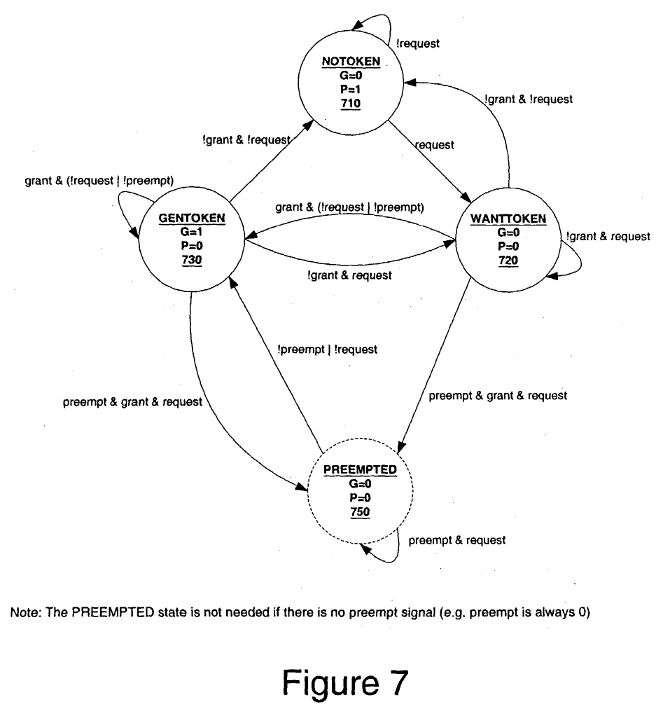

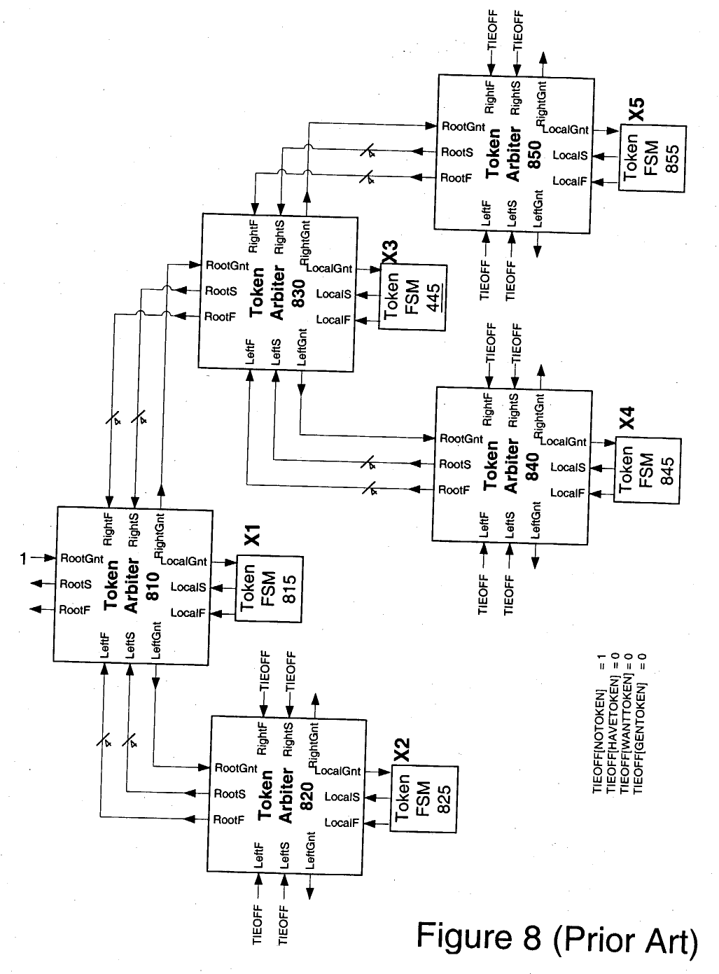

FIG. 7 illustrates one embodiment of the finite state machine. In one embodiment, the G and P signals are generated directly from the zero/one-hot encoded state of the token arbitration finite state machine (FSM) located in each requestor participating in the round robin arbitration. The state machine takes as input a request from the requester and a grant from the arbitration tree.

| STATES | Meanings |
|---|---|
| G = 1, P = 0 | Token Is here to pass, GENTOKEN |
| G = 0, P = 0 | I'm requesting the Token/I'm using the Token, |
| | WANTTOKEN |
| G = 0, P = 1 | I don't have the Token, and not requesting it, NOTOKEN |

The NOTOKEN state 710 indicates that the FSM does not have the token, and has not requested it. Therefore, the G (generate) is zero, indicating that the token is not here to pass, and P (propagate) is one, indicating that the token is not needed by this FSM. If a request is received, the state moves from NOTOKEN 710, to WANTTOKEN state 720. The WANTTOKEN state 720 indicates that the FSM does not have a token, but wants it, thus G is zero and P is zero. The FSM stays in this state, until the request has been granted. In one embodiment, in the clock cycle when the request is granted, the current request is completed. The FSM passes to the GENTOKEN state 730 when grant is active, and either there is no active request or there is no preemption. This state indicates that the token is in this sub-tree, and is ready to be passed along.

From the GENTOKEN state 730, if the token is passed to a higher priority requestor, the FSM passes the token along, and moves to the NOTOKEN state 710, where it remains until a request is again received. If, in the GENTOKEN state 730 the grant remains active (e.g. there are no other requesters), then it remains in the GENTOKEN state 730, otherwise if a request is received and not granted, the FSM moves to the WANTTOKEN state 720. In this way, the FSM moves among three states.

Additionally, in one embodiment, all the FSMs may receive a preempt signal as an input from a distributed resource. The preempt signal is a mechanism by which a higher priority requester—one that may not be part of the round robin arbitration—can be granted access to the resource. In one embodiment, during preemption the round robin arbitrates for a new owner granting the token, but delays the requestor's use of the resource until the preemption is complete. The preempt signal is a global signal that is distributed to all requestor FSMs. If the preempt signal is active while the FSM is being granted the token, and request is active, whether it is in the WANTTOKEN 720 or the GENTOKEN state 730, the FSM moves to the PREEMPTED state 750. In this state, the FSM owns the token, but is not granted use of the resource. The FSM stays in this state while the preempt and the request are active, holding the token. If the request becomes inactive, i.e. the preemption is no longer needed since the FSM does not wish to use the token, the FSM state transitions to the GENTOKEN state 730.

If the preemption becomes inactive, i.e. the higher priority arbitration finishes returning the resource to the FSM, the FSM transitions from PREEMPTED state 750 to the GENTOKEN state 730. At that point, if the request is still active, e.g. the FSM still has the request that has not been serviced, the FSM is granted use of the resource. If the request is not active, the FSM passes to the GENTOKEN state 730 without using the granted resource.

In an embodiment, a machine-readable medium may have stored thereon information representing the apparatuses and/or methods described herein. A machine-readable medium includes any mechanism that provides (e.g., stores and/or transmits) information in a form readable by a machine (e.g., a computer). For example, a machine-readable medium includes read only memory (ROM); random access memory (RAM); magnetic disk storage media; optical storage media; flash memory devices; DVD's, electrical, optical, acoustical or other form of propagated signals (e.g., carrier waves, infrared signals, digital signals, EPROMs, EEPROMs, FLASH, magnetic or optical cards, or any type of media suitable for storing electronic instructions. Slower mediums could be cached to a faster, more practical, medium. The information representing the apparatuses and/or methods stored on the machine-readable medium may be used in the process of creating the apparatuses and/or methods described herein.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. An apparatus to provide round robin token arbitration comprising:
at least two token arbiters, each token arbiter associated with a node to which at least two sub-trees are connected, each sub-tree comprising a token arbiter or a requestor.

2. The apparatus of claim 1, wherein each token arbiter has three connectors designed to receive sub-trees.

3. The apparatus of claim 1, wherein each arbiter has one local connection designed to receive a requester.

4. The apparatus of claim 1, wherein each arbiter includes a local connection, a right connection, and a left connection.

5. The apparatus of claim 4, wherein request priority is: local, right, and left.

6. The apparatus of claim 1, wherein each arbiter includes:
outputs of Grant signals to each connector designed to receive a sub-tree;
an input of a pair of signals, Generate (G) and Propagate (P), from each of the sub-trees, indicating a current state of the sub-tree.

7. The apparatus of claim 6, wherein each non-root arbiter further includes:
an input of a root grant signal indicating that a token has been granted to the arbiter; and
an output upstream of a pair of signals, G and P, indicating a current state of the arbiter.

8. The apparatus of claim 6, wherein the states indicated by the pair of signals comprise:
NoToken state indicating that the sub-tree does not have a token and does not want the token;
WantToken state indicating that the sub-tree wants the token; and
GenToken state indicating that the sub-tree has the token.

9. The apparatus of claim 1, wherein a requestor has a finite state machine requestor with three states:
NoToken state indicating that the finite state machine requestor does not have a token and does not want the token;
WantToken state indicating that the finite state machine requestor wants the token; and
GenToken state indicating that the finite state machine requester has the token.

10. The apparatus of claim 9, wherein the finite state machine requestor has an additional state of:
Preempted state indicating that the finite state machine requestor has the token, but that the round robin arbitration has been preempted by a higher priority arbitration.

11. The apparatus of claim 1, wherein the arbiters and requesters are laid out in a tree structure.

12. The apparatus of claim 11, wherein the tree structure is structured to minimize a maximum distance from the root to a furthest leaf node.

13. A machine-readable medium having stored thereon information representing the apparatus of claim 1.

14. An arbiter for a system-on-a-chip (SOC) comprising:
a root token arbiter having at least two downstream connectors to receive sub-trees;
a token arbiter coupled to one of the connectors of the root token arbiter, the token arbiter having at least two downstream connectors to receive sub-trees;
wherein each sub-tree comprises a token arbiter or a requestor.

15. The arbiter of claim 14, wherein each downstream connector includes the signals:
output signal Grant indicating that the sub-tree coupled to the connector has been granted the token;
a pair of input signals Generate (G) and Propagate (P) indicating a status of the sub-tree coupled to the token.

16. The arbiter of claim 15, wherein each token arbiter further comprises an upstream connector.

17. The arbiter of claim 16, wherein the upstream connector comprises:
a pair of output signals Generate (G) and Propagate (P) indicating the status of the token arbiter upstream; and
an input signal RootGrant indicating that the token arbiter has been granted the token.

18. The arbiter of claim 14, wherein buffered signals are output to the sub-trees coupled to the token arbiter.

19. The arbiter of claim 18, wherein the buffered signals are buffered using a high-powered buffers or inverters that drive the output of the token arbiter.

20. An arbiter comprising:
a first token arbiter to receive a local requester and at least a second token arbiter;
a second token arbiter coupled to the first token arbiter, the second token arbiter to receive at least two requesters.

21. The arbiter of claim 20, wherein one of the at least two requesters is a local requestor.

22. The arbiter of claim 20, wherein one of the at least two requestors is a remote requestor.

23. The arbiter of claim 22, wherein the remote requestor is coupled to the second token arbiter through a third token arbiter.

24. A system-on-a-chip (SOC) comprising:
a plurality of logical units;
a shared resource accessed by the plurality of logical units;
an arbitration logic to arbitration the shared resource, the arbitration logic comprising:
a finite state machine associated with each of the plurality of logical units, to generate requests for the shared resource and indicate to the logical unit when the shared resource is available for use;
the finite state machines tied together in a tree structure using token arbiters, each token arbiter having associated with it at least two sub-trees, a sub-tree comprising the finite state machine or another token arbiter.

25. A machine-readable medium having stored thereon information representing the apparatus of claim 24.

26. A tree-structured arbiter comprising:
a plurality of finite state machines comprising leaf nodes of the tree-structured arbiter, each finite state machine associated with a requestor, the finite state machine passing a state upstream with a two-wire connection;
a plurality of token arbiters comprising a root node and branch nodes, a token arbiter to receive a two-wire connection from a finite state machine, the token arbiter to determine when to grant the token to the finite state machine.

27. The arbiter of claim 26, wherein a token arbiter has a finite state machine coupled to the token arbiter.

28. The arbiter of claim 26, wherein a token arbiter has a daughter token arbiter coupled to it, the daughter token arbiter passing a two-wire connection to the token arbiter indicating a state of a sub-tree of the daughter arbiter.
